(19) United States
(12) Patent Application Publication
(10) Pub. No.: US 2014/0352528 A1
(43) Pub. Date: Dec. 4, 2014

(54) AIR SPRING WITH CONSTRAINED ELASTIC SLEEVE

(71) Applicant: Maxine C. McKenzie, Spring Lake, MI (US)

(72) Inventor: Thomas A. McKenzie, Grand Haven, MI (US)

(21) Appl. No.: 14/122,498

(22) PCT Filed: Jun. 11, 2012
(86) PCT No.: PCT/US2012/041965

§ 371 Date: Jul. 3, 2014

Related U.S. Application Data
(60) Provisional application No. 61/520,454, filed on Jun. 10, 2011.

(51) Int. Cl. B60G 17/04

(52) U.S. Cl. CPC B60G 17/04; B60G 2202/15
USPC 92/172

(57) ABSTRACT

An air spring (10) comprises a hollow elastic sleeve (12), an upper component (22) for securing the air spring to a first frame, a hollow piston (14) for securing the air spring (10) to a second frame that is movable relative to the first frame, and a cylinder (16) surrounding the hollow elastic sleeve to constrain the diameter of the hollow sleeve (12) and reduce the effective area of the air spring to reduce the natural frequency of the air spring (10).

### CROSS-REFERENCE TO RELATED APPLICATION

This application claims the benefit of U.S. Provisional Application Ser. No. 61/520,454, filed Jun. 10, 2011, which is incorporated herein in its entirety.

### BACKGROUND OF THE INVENTION

### Field of the Invention

The invention relates to rolling lobe air springs, and more particularly to an improvement that reduces the natural frequency of a rolling lobe air spring.

### BRIEF SUMMARY OF THE INVENTION

In one embodiment, air spring includes a hollow elastic sleeve. An upper component is provided to secure the air spring to a first frame, and an upper end of the hollow elastic sleeve is secured to the upper component. A hollow piston is provided to secure the air spring to a second frame that is movable relative to the first frame, and a lower end of the hollow elastic sleeve is secured to the piston. A cylinder surrounds the hollow elastic sleeve between the upper component and the piston to constrain the diameter of the hollow sleeve and thereby reduce the effective area of the air spring. This construction effectively reduces the natural frequency of the air spring.

### BRIEF DESCRIPTION OF THE DRAWINGS

In the drawings:

FIG. 1 is a schematic side view of an air spring according to a first embodiment of the invention.

FIG. 2 is a schematic side of an air spring according to a second embodiment of the invention.

### DESCRIPTION OF AN EMBODIMENT OF THE INVENTION

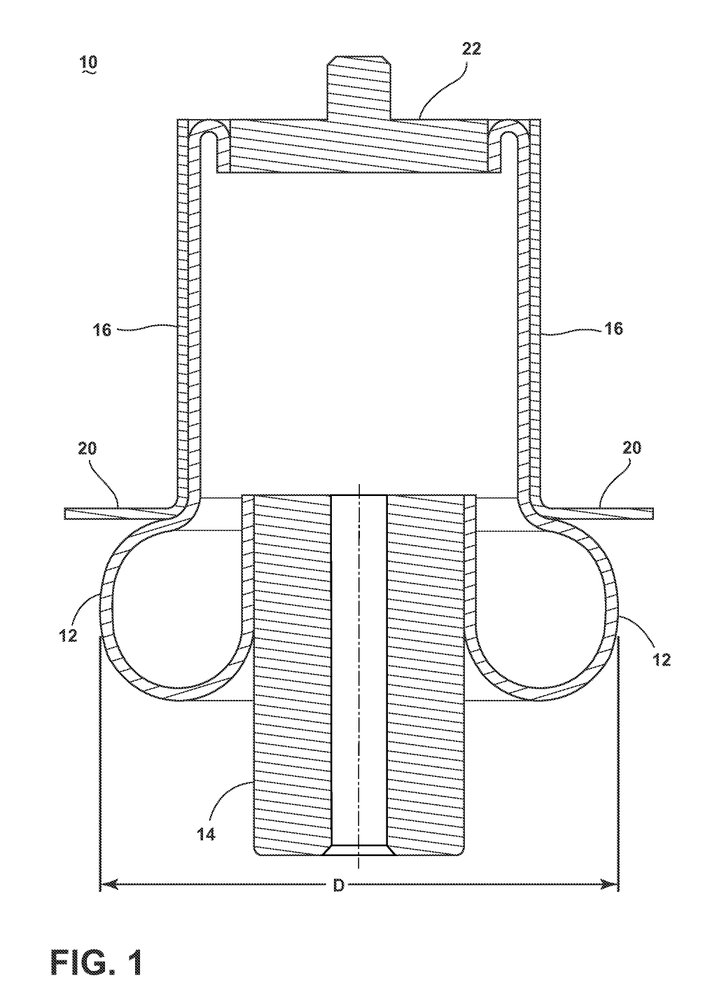

FIG. 1 illustrates an air spring (10) according to an embodiment of the invention. An air spring (10) may have an end component (22), a hollow piston (14), an elastic sleeve (12) and a cylinder (16) surrounding the elastic sleeve (12).

The air spring upper component (22) is a member that couples the air spring (10) to a first frame such as a vehicle.

The air spring piston (14) is a hollow piston that couples the air spring (10) to a second frame such as a vehicle axle.

The air spring sleeve (12) couples the upper component (22) and the piston (14). The sleeve (12) is a hollow, elastic component that acts as a deformable interconnection between the upper component (22) and the piston (14).

The cylinder (16) is a rigid cylinder placed around and in direct contact with the air spring sleeve (12). The cylinder may have a flanged bottom edge (20) on the end nearest the piston (14).

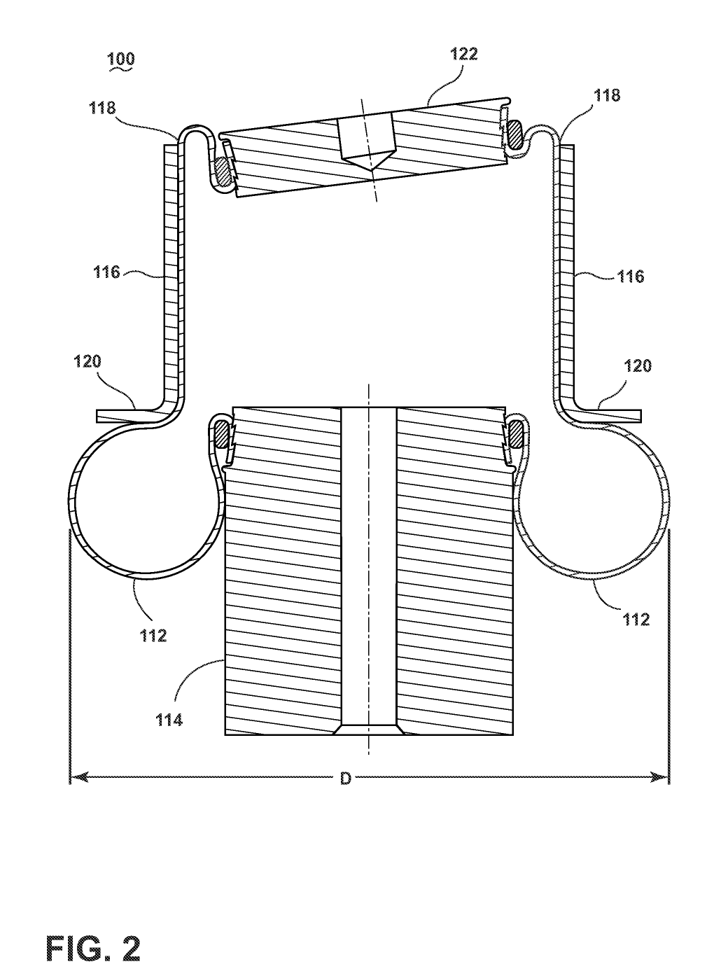

FIG. 2 illustrates an air spring according to a second embodiment. The second embodiment is similar to the first embodiment; therefore, like parts will be identified with like numerals increased by 100, with it being understood that the description of the like parts of the first embodiment applies to the second embodiment, unless otherwise noted.

One difference between the air spring (10) and the air spring (110) is that the air spring end component (122) is rolled 7 degrees. The roll is accomplished by inclining the air spring end component (122) by modifying the coupling between the end component (122) and the sleeve (118). Additionally, the cylinder (116) surrounding the elastic sleeve does not extend to the same height as the air spring sleeve (112). Consequently, there is a filleted edge (118) between the upper edge of the cylinder (116) and the sleeve (112).

The air spring (10) movably couples the first and second frames. When a force is applied to either frame, the air spring elastically transfers that force from one frame to the other. The elasticity of the transferal of force is defined by the elasticity of the sleeve (12) and the allowable degrees of freedom of the deformation of the sleeve (12).

One purpose of air spring is to act as a suspension system for a vehicle and improve the vehicle ride quality by responding smoothly when bumps are encountered. A spring reacts to a jolt such as when a vehicle hits a bump with a well-known response that defines a spring rate. A spring rate is a measure of the natural frequency of the spring and may be expressed as:

$${K}_{rate} = \frac{ζ {P}_{a} {A}_{e}}{{V}_{e}} + ( \frac{{A}_{e} - {A}_{e 1}}{- 1} ) {P}_{g}$$

Where Kᵣₐₜₑ is the spring rate, Aₑ is the effective area of the spring as calculated below. Aₑ₁ is the effective area of the spring after 1 inch of stroke of the piston, P_{g} is gauge pressure, Pₐ is atmospheric pressure, and Vₑ is effective volume. ζ is a spring constant, normally equal to 1.3ε. The effective area is a function of D, the major diameter and d, the minor diameter and is expressed as:

$${A}_{e} = {[ \frac{( D + d )}{2} ]}^{2} 9 π / 4 ,$$

where D is the major diameter as described below and d is the piston diameter.

A smooth response is one defined as having a lower natural frequency. The response is a function of the major diameter of the air spring, where the major diameter is the maximum diameter of the spring. To reduce the natural frequency of an air spring, the effective area of the spring can be reduced. One way to reduce the effective area of the spring is to reduce the major diameter.

The air spring (10) is a type of rolling lobe air spring. A rolling lobe air spring reacts to changes in force by allowing the elastic sleeve (12) to roll along the piston (14). In a typical rolling lobe air spring, the diameter of the elastic sleeve will increase in response to force applied to the air spring (22). The effective area reduction cylinder (16) constrains the diameter of the air spring (10) by limiting the maximum deflection of the sleeve (12) away from the piston. This is accomplished by reducing the amount of the sleeve (12) that is allowed to form the major diameter D as force is applied to the air spring (10).

By reducing the majority of the air spring sleeve (12) from deflecting outwards with the effective area reduction cylinder (16) and allowing a small amount of sleeve (12) to form the major diameter D, the effective area is reduced based on the size of the radius of the meniscus loop formed by the sleeve (12) along the piston (14). The smaller the loop, the faster the effective area is reduced; thus lowering the frequency faster. This method along with an hourglass or negative tapered piston, as is well-known in the art, would increase the reduction of effective area. During testing with a neutral tapered piston the spring rate was reduced by 38%.

The air spring of the current invention may be embodied to use other techniques known in the art for reducing the natural frequency of the spring. For example, the embodiment of the invention in FIG. 2 is shown with an inclination of 7 degrees. Inclining the spring is another technique known to reduce the natural frequency of the spring.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. An air spring (10) comprising:
a hollow elastic sleeve (12);
an upper component (22) for coupling the air spring (10) to a first frame, wherein an upper end of the hollow elastic sleeve (12) is secured to the upper component (22);
a piston (14) for coupling the air spring (10) to a second frame that is movable relative to the first frame, wherein a lower end of the hollow elastic sleeve (12) is secured to the piston (14); and
a hollow cylinder (16) having a first end circumscribing the upper component (22) and an opposed second end terminating in an outwardly-disposed flange (20) circumscribing the second end, the hollow cylinder (16) circumscribing the hollow elastic sleeve (12) intermediate the upper component (22) and the outwardly-disposed flange (20) to constrain the diameter of the hollow sleeve (12) and thereby reduce the effective area and natural frequency of the air spring (10).

2. The air spring (10) of claim 1 wherein the hollow cylinder (16) is rigid.

3. The air spring (10) of claim 2 wherein the hollow cylinder (16) enables an inflation pressure of the hollow elastic sleeve (12) to increase without rupture.

4. The air spring (10) of claim 1 wherein the hollow cylinder (16) is located so that more of the elastic sleeve (12) is exposed between the piston (14) and the hollow cylinder (16) than between the upper component (22) and the hollow cylinder (16).

5. The air spring (10) of claim 1 wherein the piston (14) has a negative taper to increase a rate of change in the reduction of the effective area.

6. The air spring (10) of claim 1 wherein the outwardly-disposed flange (20) extends radially away from the hollow cylinder (16).

7. An air spring (10) according to claim 1 wherein the upper component (22) and hollow cylinder (16) define an axis passing through the center of the upper component (22) and longitudinally through the center of the hollow cylinder (16), and wherein the coupling of the hollow elastic sleeve (12) with the upper component (22) includes a fold in the hollow elastic sleeve (12) between the upper component (22) and the hollow cylinder (16) to enable the upper component (22) to tilt relative to the axis.

8. An air spring (10) according to claim 7, and further comprising a fillet (118) around an inside edge of the hollow cylinder (16) adjacent the fold in the hollow elastic sleeve (12).

9. An air spring (10) comprising:
a hollow elastic sleeve (12);
an upper component (22) for coupling the air spring (10) to a first frame, wherein a first end of the hollow elastic sleeve (12) is secured to the upper component (22);
a piston (14) having a first outer diameter and coupling the air spring (10) to a second frame that is movable relative to the first frame; and
a hollow cylinder (16) surrounding the hollow elastic sleeve (12) from the upper component (22) to the piston (14) to constrain the diameter of the hollow elastic sleeve (12);
whereby the second opposed end of the hollow elastic sleeve (12) is secured to the piston (14) to define a rolling lobe that is alternatingly drawn into and out of the hollow cylinder (16) as the piston (14) moves toward and away from the upper component (22); and
whereby the diameter of the rolling lobe decreases as the rolling lobe is drawn into the hollow cylinder (16) to thereby reduce the effective area and the natural frequency of the air spring (10).

10. An air spring (10) comprising:
an upper component (22) for coupling the air spring (10) to a first frame;
a piston (14) having a piston (14) outside diameter and secured to a second frame that is movable relative to the first frame;
a hollow cylinder (16) having a cylinder (16) inside diameter greater than the piston (14) outside diameter, the hollow cylinder (16) including a first end immovably surrounding the upper component (22) and a second opposed end terminating in an outwardly-disposed flange (20) circumscribing the second end, and
an inflatable elastic gas receptacle having a first end and an opposed second end, the first end of the inflatable elastic gas receptacle secured to the upper component (22), and the opposed second end of the inflatable elastic gas receptacle secured to the piston (14);
whereby the hollow cylinder (16) from the first end to the outwardly-disposed flange (20) surrounds a portion of the inflatable elastic gas receptacle (12) to constrain the diameter of the portion of the inflatable elastic gas receptacle (12);
whereby the second end of the inflatable elastic gas receptacle (12) is secured to the piston (14) to define a rolling lobe extending away from the outwardly-disposed flange (20);
whereby the rolling lobe is alternatingly drawn into and out of the hollow cylinder (16) as the piston (14) moves toward and away from the upper component (22); and
whereby the diameter of the rolling lobe decreases as the rolling lobe is drawn into the hollow cylinder (16) to thereby reduce the effective area and the natural frequency of the air spring (10).

11. An air spring (10) according to claim 10 wherein, as the rolling lobe is drawn into the hollow cylinder (16) as the piston (14) moves toward the upper component (22), the volume of the rolling lobe decreases.
